(19) United States
(12) Patent Application Publication
(10) Pub. No.: US 2008/0069181 A1
(43) Pub. Date: Mar. 20, 2008

(54) Method for detection and avoidance of ultra wideband signal and ultra wideband device for operating the method

(75) Inventors: Jeong Sang Lee, Yongin-si (KR); Jae Ho Roh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/707,898

(22) Filed: Feb. 20, 2007

(30) Foreign Application Priority Data
Sep. 15, 2006 (KR) 10-2006-0089788

(51) Int. Cl. H04B 1/00

(52) U.S. Cl. 375/130; 375/E01.001

(57) ABSTRACT

A DAA method of a UWB signal with respect to a WiMax signal, the method including: generating the UWB signal by tone mapping a predetermined data bit; and controlling a first band to shift to a second band where an interference with the WiMax signal occurs, the first band including a null tone among mapped tones of the UWB signal.

### CROSS-REFERENCE TO RELATED APPLICATION

This application claims priority from Korean Patent Application No. 10-2006-0089788, filed on Sep. 15, 2006, in the Korean Intellectual Property Office, the entire disclosure of which is incorporated herein by reference.

### BACKGROUND OF THE INVENTION

1. Field of the Invention

Methods and apparatuses consistent with the present invention relate to detection and avoidance (DAA) of an Ultra-Wideband (UWB) signal and a UWB terminal for performing the same. More particularly, the present invention relates to a DAA method of a UWB signal which can reduce interference, which occurs between the UWB signal and a wireless communication network signal, such as a World Interoperability for Microwave Access (WiMax) signal, and the like, due to a comparatively wide bandwidth of the UWB signal, by shifting a null tone band of the UWB signal to an interference band, and a UWB terminal for performing the method.

2. Description of Related Art

Ultra-Wideband (UWB) communication can co-exist with an existing wireless communication service without separately securing frequency resources, and also can wirelessly communicate in a high speed wideband. Currently, studies regarding UWB communication are being actively pursued.

UWB transmits data using a comparatively very short pulse of a few nanoseconds, and thus has different features from other existing narrowband communication. Specifically, since the UWB usually transmits a signal by using a pulse, UWB has a comparatively wide frequency band and a small transmission power density. Also, since the UWB utilizes a wide bandwidth, the UWB may quickly transmit data with a comparatively small amount of power consumption. Also, the UWB may achieve multi-access and maintain communication even in a noisy band.

UWB may be applicable in various types of fields. Particularly, UWB may be applicable to short-range communication within about 10 m. Since UWB may quickly transmit data in comparison to existing short-range communication schemes, such as Bluetooth, Zigbee, and the like, UWB is in the spotlight as a next generation short-range communication technology.

However, due to its wide bandwidth, UWB may collide with service bands of other wireless communication networks. Thus, governments specify the limit of emission power so that a UWB signal may not interfere with existing channels. Specifically, with the assumption that power is maintained to be less than a certain reference value with respect to a corresponding band of UWB where an interference with a service band of a particular wireless communication network occurs, a UWB communication service is allowed.

For example, in the U.S.A. a UWB communication band is required to be within a range of about 3.1 GHz to about 10.6 GHz, and the emission power is limited to −41.3 dBm. Also, there is a constraint on a power level to reduce interference with respect to other bands. Specifically, a band of about 0.96 GHz to about 1.61 GHz is limited to a comparatively very low power level due to possible interference with a Global Positioning System (GPS).

Also, like the U.S.A., European countries have specified the UWB communication band to be within the range of about 3.1 GHz to about 10.6 GHz and limited the power emission limit to −41.3 dBm. Particularly, in European countries, collision with World Interoperability for Microwave Access (WiMax) communication becomes an issue. Here, while −65 dBm/MHz of a Narrowband Signal Protection Level is required for WiMax, a Signal Level of UWB is −41.3 dBm/MHz. Thus, a level difference between the WiMax and the UWB is 23.7 dBm/MHz. Therefore, it is required to decrease transmission power in a particular band of UWB where an interference with WiMax occurs, to about 23.7 dBm/MHz.

Accordingly, a detection and avoidance (DAA) technology which can reduce an interference between a UWB communication and a wireless communication scheme, such as WiMax, and the like, by utilizing a comparatively simple method and thereby significantly decrease the power of a corresponding band is required.

### SUMMARY OF THE INVENTION

The present invention provides a DAA method of a UWB which can shift a null tone band of a UWB signal to a band where an interference with a predetermined wireless communication network signal occurs, and thereby effectively solve an interference between the UWB signal and other wireless communication network signals with a simple scheme, and a UWB terminal of performing the method.

The present invention also provides a DAA method of a UWB signal which can reduce data loss when DAA of a UWB signal is performed, since only a single tone is changed into a null tone, and a UWB terminal of performing the method. Here, the single tone becomes a direct current (DC) term according to a shift, when a null tone band of the UWB signal is shifted.

The present invention also provides an economical and effective DAA method of a UWB signal which can carry out a DAA operation by simply shifting a tone mapping of a UWB signal and thus does not require a redesign with respect to each module of a UWB terminal, and the UWB terminal of performing the method.

The present invention also provides a DAA method of a UWB signal which can significantly decrease a power of a corresponding band of a UWB signal where an interference with a predetermined wireless communication network signal occurs by inverting a sign of at least one tone, which is included in a guard band, or changing the at least one tone into a null tone, and a UWB terminal of performing the method. Here, the guard band is provided around the null tone of the shifted UWB signal.

According to an aspect of the present invention, there is provided a DAA method of a UWB signal with respect to a WiMax signal, the method including: generating the UWB signal by tone mapping a predetermined data bit; and controlling a first band to shift to a second band where an interference with the WiMax signal occurs, the first band including a null tone among mapped tones of the UWB signal.

According to another aspect of the present invention, there is provided a DAA method of a UWB signal with respect to a WiMax signal, the method including: generating the UWB signal by tone mapping a predetermined data bit; inverting a sign of at least one tone, which is included in a guard band, or changing the at least one tone into a null tone among mapped tones of the UWB signal; and controlling a first band to shift to a second band where an interference with the WiMax signal occurs, the first band including the null tone among the mapped tones of the UWB signal.

According to still another aspect of the present invention, there is provided a DAA method of a UWB signal with respect to a WiMax signal, the method including: generating the UWB signal by tone mapping a predetermined data bit; controlling a first band to shift to a second band where an interference with the WiMax signal occurs, the first band including a null tone among the mapped tones of the UWB signal; and changing a tone, which becomes a DC term according to the shift, into the null tone among the mapped tones of the UWB signal.

According to yet another aspect of the present invention, there is provided a DAA method of a UWB signal with respect to a WiMax signal, the method including: generating the UWB signal by tone mapping a predetermined data bit; inverting a sign of at least one tone, which is included in a guard band, or changing the at least one tone into a null tone among the mapped tones of the UWB signal; controlling a first band to shift to a second band where an interference with the WiMax signal occurs, the first band including the null tone among the mapped tones of the UWB signal; and changing a tone, which becomes a DC term according to the shift, into the null tone among the mapped tones of the UWB signal.

According to another aspect of the present invention, there is provided a DAA method of a UWB signal with respect to a predetermined wireless communication network signal, the method including: generating the UWB signal by tone mapping a predetermined data bit; controlling information about a second band, which includes at least one tone interfering with the wireless communication network signal, among mapped tones of the UWB signal; and controlling a first band to shift to the second band, the first band including a null tone among the mapped tones of the UWB signal.

According to another aspect of the present invention, there is provided a DAA method of a UWB signal with respect to a predetermined wireless communication network signal, the method including: generating the UWB signal by tone mapping a predetermined data bit; inverting a sign of at least one tone, which is included in a guard band, or changing the at least one tone into a null tone among the mapped tones of the UWB signal; recognizing a second band, which includes at least one tone interfering with the wireless communication network signal, among the mapped tones of the UWB signal; calculating a shift value to shift a tone of a first band, which includes the null tone among the mapped tones of the UWB signal, to the second band to thereby include a tone of the second band; changing a tone, which becomes a DC term according to the shift, into the null tone among the mapped tones of the UWB signal; and controlling the first band to shift to the second band according to the calculated shift value.

According to another aspect of the present invention, there is provided a UWB terminal including: a tone mapping module which generates a UWB signal by tone mapping a predetermined data bit; a DAA control module which controls information about a second band that includes at least one tone interfering with a wireless communication network signal among mapped tones of the UWB signal; and a shift control module which controls a first band to shift to the second band, the first band including a null tone among the mapped tones of the UWB signal.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a UWB terminal according to an exemplary embodiment of the present invention;

FIG. 2 is a block diagram illustrating a configuration of a UWB transmitting apparatus for performing a DAA operation of a UWB signal, and the DAA operation according to an exemplary embodiment of the present invention;

FIG. 3 illustrates tone mapping according to a WiMedia UWB specification;

FIG. 4 illustrates a frequency band of a UWB signal where interference between the UWB signal and a WiMax signal occurs;

FIG. 5 illustrates a frequency band of a UWB signal where a null tone band is cyclic-shifted to a band where an interference with a WiMax signal occurs according to an exemplary embodiment of the present invention;

FIG. 6 is a block diagram illustrating a partial configuration of a UWB transmitting terminal and a UWB receiving terminal according to an exemplary embodiment of the present invention;

FIG. 7 illustrates a configuration of a guard band of a UWB signal;

FIG. 8 illustrates a configuration of a guard band where a sign of at least one tone, which is included in the guard band, is inverted according to an exemplary embodiment of the present invention;

FIG. 9 illustrates a guard band where at least one tone, which is included in a guard band, is changed into a null tone according to an exemplary embodiment of the present invention;

FIG. 10 illustrates results of DAA which is carried out by applying a notch filter to a null tone band of a UWB signal with respect to a WiMax signal according to a conventional art;

FIG. 11 illustrates results of DAA which is carried out by shifting a null tone band of a UWB signal to a band where an interference with a WiMax signal occurs according to an exemplary embodiment of the present invention;

FIG. 12 illustrates results of DAA which is carried out by shifting a null tone band of a UWB signal to a band where an interference with a WiMax signal occurs, and changing all tones of a guard band into null tones according to an exemplary embodiment of the present invention;

FIG. 13 is a flowchart illustrating a DAA method of a UWB signal with respect to a WiMax signal according to an exemplary embodiment of the present invention; and

FIG. 14 is a flowchart illustrating a DAA method of a UWB signal with respect to a predetermined wireless communication network signal according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

A DAA method of a UWB signal according to the present invention may be applicable to any type of wireless communication network signal when up to five tones are included in a band where an interference occurs. Specifically, when an interference between a UWB signal and a predetermined wireless communication network signal occurs, and less than five tones are included in an interference section of the UWB signal, the DAA method of the UWB signal according to the present invention may be applied to the wireless communication network signal.

In this instance, the DAA method of the UWB signal according to the present invention will be described by taking a World Interoperability for Microwave Access (WiMax) signal as an example, for convenience of description. Also, among various UWB specifications, the WiMedia UWB specification will be described in an exemplary embodiment of the present invention.

Hereinafter, the present exemplary embodiments of the present invention will be described in detail with reference to the accompanying drawings.

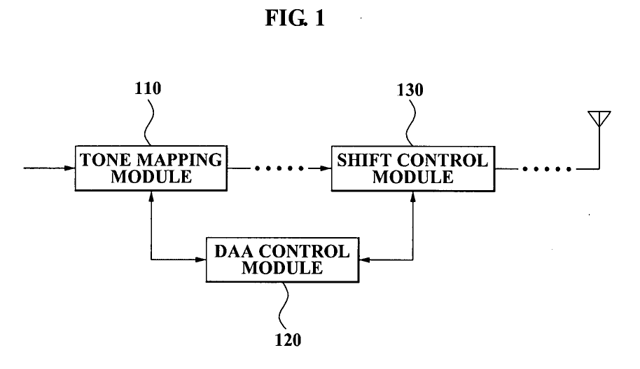

FIG. 1 is a block diagram illustrating a configuration of a UWB terminal according to an exemplary embodiment of the present invention.

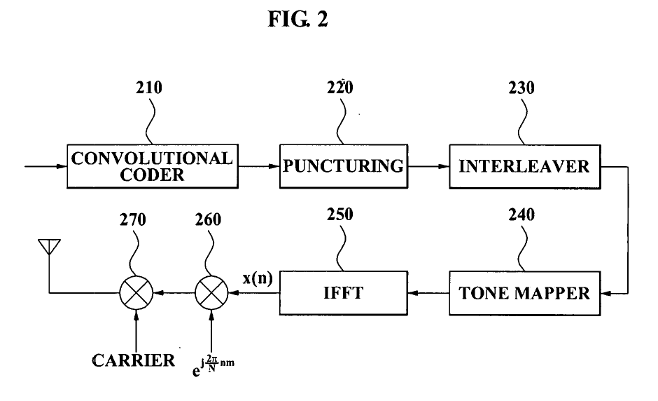

FIG. 2 is a block diagram illustrating a configuration of a UWB transmitting apparatus for performing a DAA operation of a UWB signal, and the DAA operation according to an exemplary embodiment of the present invention.

Referring to FIG. 1, the UWB terminal according to an exemplary embodiment of the present invention includes a tone mapping module 100, a DAA control module 120, and a shift control module 130. Each module of the UWB terminal illustrated in FIG. 1 may be constructed to partially correspond to a configuration of the UWB transmitting apparatus illustrated in FIG. 2. Specifically, the tone mapping module 110 and the DAA module of FIG. 1 may include a tone mapper 240 of FIG. 2. Also, the shift control module 130 of FIG. 1 may include a first multiplier 260 of FIG. 2.

A general UWB transmitting apparatus may transmit a UWB signal to a receiver by performing convolutional coding, puncturing, interleaving, tone mapping, inverse fast Fourier transforming (IFFT), and modulating.

The UWB transmitting apparatus according to an exemplary embodiment of the present invention includes the configuration and operation of the general UWB transmitting apparatus, as described above. Also, as illustrated in FIG. 2, the UWB transmitting apparatus according to the present embodiment may further include the first multiplier 260 which multiplies a predetermined index function signal and a UWB signal outputted from an IFFT 250. As described above, the first multiplier 260 may be included in the shift control module 130 of FIG. 1. Also, the tone mapper 240 may be constructed to perform tone mapping according to a UWB signal spec and also perform a configuration and operation of the DAA control module 120, which will be described later.

Referring again to FIG. 1, the tone mapping module 110 generates a UWB signal by tone mapping a predetermined data bit. According to the present embodiment, the tone mapping module 110 may tone map the data bit according to the WiMedia UWB specification. In addition to the WiMedia UWB specification, the tone mapping module 110 may tone map the data bit according to any other UWB specification.

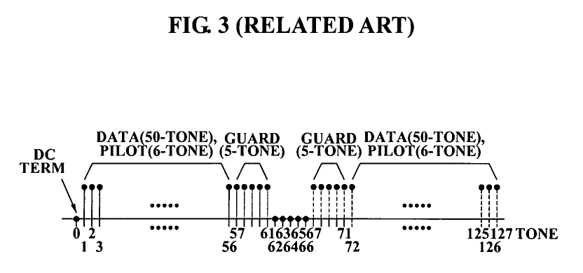

FIG. 3 illustrates tone mapping according to the WiMedia UWB specification.

As illustrated in FIG. 3, the tone mapping module 110 may tone map the data bit according to the WiMedia UWB specification. According to the WiMedia UWB specification, 128 tones of a UWB signal may be mapped in a bandwidth of 528 MHz. Thus, a single tone has a frequency band of 4.125 MHz.

Here, the 128 tones may be classified into 0^{th} to 127^{th} tones. In this instance, the above-described classification method is for convenience of description and thus the tones may be classified by various types of methods. For example, the 128 tones may be classified into 64^{th} to 63^{rd} tones. Also, tone mapping according to the WiMedia UWB specification may be cyclic-shifted.

Six tones are set to null tones among the 128 tones, which are tone mapped according to the WiMedia UWB specification. In this instance, according to the WiMedia UWB specification, one of six null tones becomes a direct current (DC) term and a remaining five null tones are consecutively set to a 62^{nd} tone, a 63^{rd} tone, a 64^{th} tone, a 65^{th} tone, and a 66^{th} tone.

Also, a first guard band and a second guard band may be provided around the remaining five null tones. Specifically, a 57^{th} tone, a 58^{th} tone, a 59^{th} tone, a 60^{th} tone, and a 61^{th} tone may be set to the first guard band. Also, a 67^{th} tone, a 68^{th} tone, a 69^{th} tone, a 70^{th} tone, and a 71^{st} tone may be set to the second guard band.

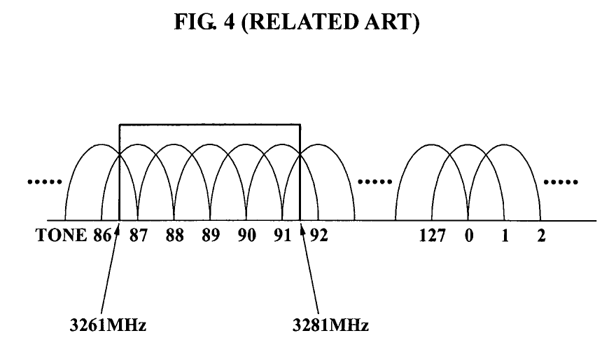

FIG. 4 illustrates a frequency band of a UWB signal where an interference between the UWB signal and a WiMax signal occurs.

Due to a wide bandwidth of the UWB signal, the UWB signal may cause interference with various wireless communication network signals. As illustrated in FIG. 4, an interference between the UWB signal and a WiMax signal may occur in a band of 87^{th} to 91^{st} tones. The band of the 87^{th} to 91^{st} tones has a frequency band of 3261 MHz to 3281 MHz.

Generally, a band where an interference between the WiMax signal and the UWB signal occurs correspond to a single tone of the UWB signal, i.e. the 89^{th} tone of the UWB signal. However, to solve an indirect interference phenomenon according to a side lobe and thereby more effectively reduce the interference, in the present invention, the band where the interference occurs may be set to a band of five tones, i.e., the 87^{th} to 91^{st} tones.

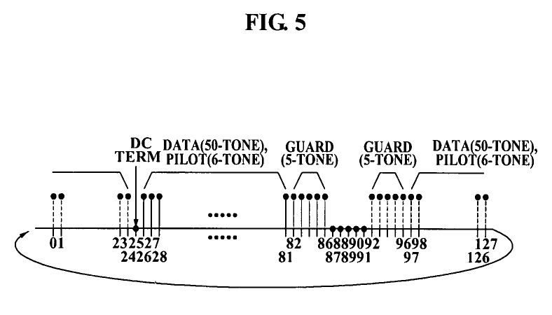

Referring again to FIG. 1, the shift control module 130 controls a first band to shift the first band to a second band where an interference with the WiMedia signal occurs, which will be described with reference to FIG. 5. Here, the first band includes the null tones among the mapped tones of the UWB signal.

FIG. 5 illustrates a frequency band of a UWB signal where a null tone band is cyclic-shifted to a band where an interference with a WiMax signal occurs according to an exemplary embodiment of the present invention.

As described above, the shift control module 130 shifts the first band to the second band. Here, the first band designates a band which includes five null tones corresponding to 62^{nd} to 66^{th} tones among 128 tones of the UWB signal. Also, the second band designates a band which includes the frequency band of the UWB signal where the interference with the WiMax signal occurs, i.e., a band which includes five tones corresponding to 87^{th} to 91^{st} tones.

The shift control module 130 may shift the first band to the second band by multiplying the UWB signal by a predetermined index function signal. When the UWB signal is fast Fourier transformed and interpreted in the frequency band, it may be expressed as

$$X ( k ) = {\sum }_{n = 0}^{N - 1} x ( n ) \cdot {e}^{- j \frac{2 π}{N} nk} \qquad [ Equation 1 ]$$

Here, k designates an index in the frequency band and n designates an index in a temporal area. The shift control module 130 may shift the first band to the second band by multiplying the UWB signal X(k) by the index function signal

$${e}^{j \frac{2 π}{N} nm}$$

via a multiplier and is given by

$$\begin{matrix}{X}^{′} ( k ) = {\sum }_{n = 0}^{N - 1} x ( n ) \cdot {e}^{j \frac{2 π}{N} nm} \cdot {e}^{- j \frac{2 π}{N} nk} \\ = {\sum }_{n = 0}^{N - 1} x ( n ) \cdot {e}^{- j \frac{2 π}{N} n ( k - m )} \\ = X ( k - m )\end{matrix} \qquad [ Equation 2 ]$$

As shown in Equation 2, by multiplying the index function signal and the UWB signal, the tone of the frequency band of the UWB signal is shifted by m. Here, m may be set to be up to the same number of shifted tones of the UWB signal. For example, in the case of the WiMax signal, m may be set to have a value of 25. Thus, 62^{nd} to 66^{th} tones corresponding to a null tone band of the UWB signal may be shifted to a band of 87^{th} to 91^{st} tones where the interference with the WiMax signal occurs.

As described above, when the first band corresponding to the null tone band of the UWB signal is shifted to the second band where the interference with the WiMax signal occurs, DAA of the UWB signal with respect to the WiMax signal may be carried out. Specifically, the DAA may be carried out by only shifting the null tone band of the UWB signal to the band where the interference occurs, without changing all tones of the interference band into null tones.

In addition to the WiMax signal, shifting of the null tone band of the UWB signal, as described above, may be carried out with respect to other wireless communication network signals. Specifically, DAA according to a shift of the null tone band may be carried out with respect to any type of wireless communication network signal which has up to five tones of a band where an interference with the UWB signal occurs. Also, DAA with respect to various types of wireless communication network signals may be carried out by changing an m value of the index function signal according to the band where the interference with the wireless communication network signal occurs.

The UWB signal has a cyclic property in that data has a period of 2π in the frequency band. Thus, as illustrated in FIG. 5, even when the tone of the UWB signal is shifted, only a tone mapping location of data is changed due to the cyclic property, and contained information is not changed.

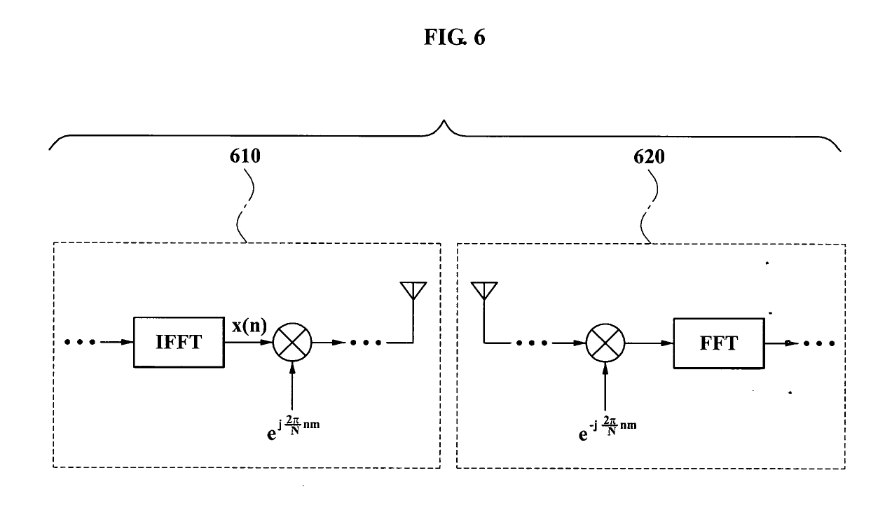

FIG. 6 is a block diagram illustrating a partial configuration of a UWB transmitting terminal 610 and a UWB receiving terminal 620 according to an exemplary embodiment of the present invention.

The multiplication of a UWB signal and an index function signal, as described above, may be performed via a multiplier of the UWB transmitting terminal 610. Specifically, the UWB transmitting terminal 610 may multiply an inverse fast Fourier transformed UWB signal X(n) by a first index function signal

$${e}^{j \frac{2 π}{N} nm}$$

via the multiplier, modulate the UWB signal into a carrier, and transmit the modulated UWB signal to the UWB receiving terminal 620.

The UWB receiving terminal 620 may receive the UWB signal from the UWB transmitting terminal 610 and demodulate the UWB signal, and then multiply the demodulated UWB signal by a second function index

$${e}^{- j \frac{2 π}{N} nm}$$

via the multiplier. Specifically, tone mapping of the shifted UWB signal by the multiplication of the UWB signal and the first index function signal may be inverse shifted to original tone mapping by multiplying the UWB signal by the second index function signal. The UWB receiving terminal 620 may perform FFT with respect to the inverse shifted UWB signal and then interpret information which is included in the UWB signal.

Referring again to FIG. 1, the DAA control module 120 controls information about a second band, which includes at least one tone interfering with the wireless communication network signal, among mapped tones of the UWB signal. Specifically, with respect to a predetermined wireless communication network signal which requires DAA, the DAA control module 120 recognizes a frequency band of a UWB signal where an interference with the wireless communication network signal occurs. Here, the frequency band where the interference occurs may be recognized by receiving associated information from an external source.

The DAA control module 120 recognizes the frequency band where the interference occurs, i.e., the second band; and calculates an m value of the index function signal. The DAA control module 120 may set the calculated m value with respect to the index function signal and then, the shift control module 130 may control the first band to shift the first band to the second band by multiplying the UWB signal by the index function signal set with the calculated m.

Also, the DAA control module 120 may adjust at least one tone, which is included in a guard band, among the mapped tones of the UWB signal. Here, due to an affect by a ripple of tones of a guard band which is provided around a null tone band of the UWB signal, a power level of the band where the interference occurs may not be significantly decreased. Thus, the DAA control module 120 may adjust the tone of the guard band. Specifically, the DAA control module 120 may invert a sign of at least one tone which is included in the guard band, or change the at least one tone into a null tone.

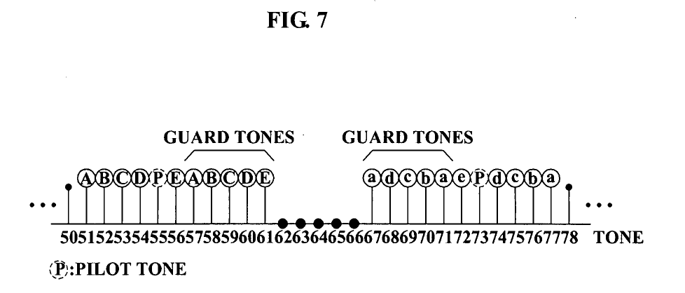

FIG. 7 illustrates a configuration of a guard band of a UWB signal.

According to the WiMedia UWB specification, as illustrated in FIG. 7, two guard bands are provided on both sides of a null tone band. Specifically, a first guard band includes 57^{th} to 61^{st} tones, and a second guard band includes 67^{th} to 71^{st} tones. The same data as data of a previous or subsequent tone is included in each corresponding tone in each of the first guard band and the second guard band.

Specifically, according to the WiMedia UWB specification, data of previous tones may be duplicated in each corresponding tone which is included in the first guard band. For example, when data A is included in a 51^{st} tone, data B in a 52^{nd} tone, data C in a 53^{rd} tone, data D in a 54^{th} tone, and data E in a 56^{th} tone, the data A may be duplicated in a 57^{th} tone of the first guard band, the data B may be duplicated in a 58^{th} tone, the data C may be duplicated in a 59^{th} tone, the data D may be duplicated in a 60^{th} tone, and the data E may be duplicated in a 61^{st} tone, respectively. Here, a 55^{th} tone may be set as a pilot tone.

Also, according to the WiMedia UWB specification, data of subsequent tones may be duplicated in each corresponding tone which is included in the second guard band. For example, when data e is included in a 72^{nd} tone, data d in a 74^{th} tone, data c in a 75^{th} tone, data b in a 76^{rd} tone, and data a in a 77^{th} tone, the data e may be duplicated in a 67^{th} tone of the second guard band, the data d may be duplicated in a 68^{th} tone, the data C may be duplicated in a 69^{th} tone, the data b may be duplicated in a 70^{th} tone, and the data a may be duplicated in a 71^{st} tone, respectively. Here, a 73^{rd} tone may be set as a pilot tone.

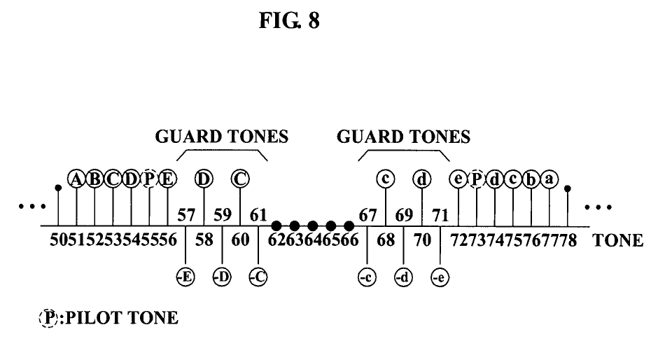

FIG. 8 illustrates a configuration of a guard band where a sign of at least one tone, which is included in the guard band, is inverted according to an exemplary embodiment of the present invention.

According to the present exemplary embodiment, the DAA control module 120 may invert the sign of the at least one tone that is included in the guard band. Specifically, when DAA with respect to a WiMax signal is carried out, the DAA control module 120 may invert a sign of the 57^{th} tone, a sign of the 59^{th} tone, and a sign of the 61^{st} tone, among the tones of the first guard band, as illustrated in FIG. 8. Also, the DAA control module 120 may invert a sign of the 67^{th} tone, a sign of the 69^{th} tone, and a sign of the 71^{st} tone, among the tones of the second guard band.

Like a UWB signal, tones, which construct an orthogonal frequency division multiplexing (OFDM) symbol, have a spectrum in a form of a sink. Specifically, an interference may occur in an area of different tones due to ripple of a side lobe. Thus, as illustrated in FIG. 8, when constructing the guard band by inverting signs for particular tones among tones of the guard band, an interference cancellation effect may result and thus, the interference with respect to the null tone band may be reduced.

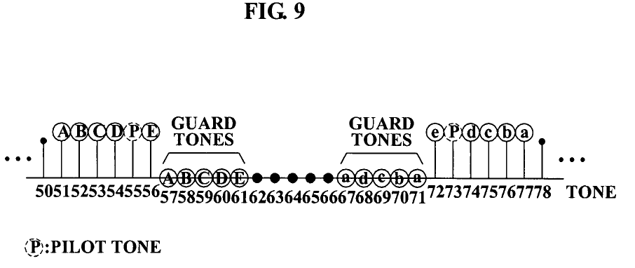

FIG. 9 illustrates a guard band where at least one tone, which is included in a guard band, is changed into a null tone according to an exemplary embodiment of the present invention.

According to the present embodiment, the DAA control module 120 may change at least one tone, which is included in the guard band, into a null tone. Specifically, when DAA with respect to a WiMax signal is carried out, the DAA control module 120 may change all tones, i.e., the 57^{th} to 61^{st} tones, which are included in the first guard, into null tones, as illustrated in FIG. 9. Also, the DAA control module 120 may invert all tones, i.e. the 67^{th} to 71^{st} tones, which are included in the second guard band, into null tones.

As described above, when changing a tone of the guard band into a null tone, a power level of a band where an interference occurs may be reduced to a satisfactory extent and thus, the DAA may be more securely carried out. Although it has been described with FIG. 9 that all tones of the guard band are changed into null tones, a number of tones to be changed into the null tones may be variously determined depending upon an intent of a system designer of ordinary skill in the art.

As described above, at the same time of adjusting the tone of the guard band, the DAA control module 120 changes a tone, which becomes a DC term according to the shift, into the null tone among the mapped tones of the UWB signal. Specifically, since the DC term must be set to the null tone, the term, which becomes the new DC term according to the shift, may be changed into the null tone.

For example, referring to FIG. 5, when DAA with respect to the WiMax signal is carried out, the DC term may be set to a 0^{th} tone. However, when the shift is performed, the DC term may be newly set to a 25^{th} tone. Thus, the DAA control module 120 may adjust the guard band and simultaneously change the term, which becomes the DC term, into the null tone.

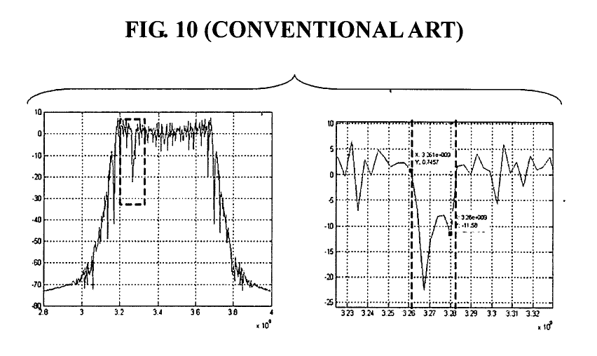

FIG. 10 illustrates results of DAA which is carried out by applying a notch filter to a null tone band of a UWB signal with respect to a WiMax signal according to a conventional art.

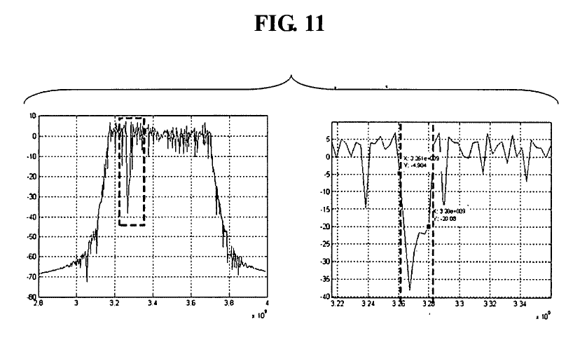

FIG. 11 illustrates results of DAA which is carried out by shifting a null tone band of a UWB signal to a band where an interference with a WiMax signal occurs according to an exemplary embodiment of the present invention.

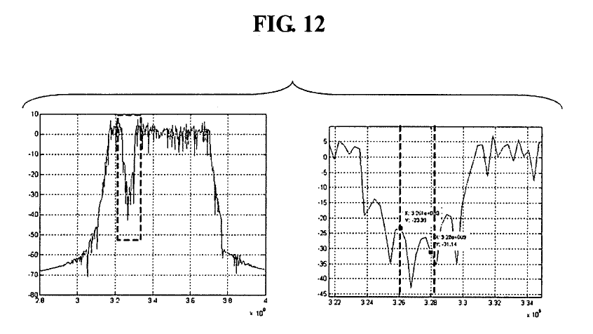

FIG. 12 illustrates results of DAA which is carried out by shifting a null tone band of a UWB signal to a band where an interference with a WiMax signal occurs, and changing all tones of a guard band into null tones according to an exemplary embodiment of the present invention.

FIGS. 10 through 12 illustrate comparison results which are acquired by randomly generating 100 bit data, mapping the generated bit data according to a standard of 53.3/80 Mbps and modulating mapped tones.

In FIGS. 10 through 12, left-hand graphs show results before the DAA is carried out and right-hand graphs show the results after the DAA is carried out. When DAA of a UWB signal with respect to a WiMax signal is carried out, 23 dBm/MHz of power level deduction is required in a band where the interference occurs.

In the conventional art, to reduce a power level of a band where an interference between the UWB signal and the wireless communication network signal occurs, a method of changing five tones of a corresponding UWB signal into null tones is suggested. However, in this case, data corresponding to the tones may be lost. Also, the power level of a corresponding band may not be sufficiently dropped.

Also, Nokia suggests a method of utilizing a notch filter and thereby, reducing the power level of a corresponding band to reduce an interference around the band. However, since the method utilizes the notch filter in the corresponding band, data corresponding to five tones of the UWB signal where an interference with the WiMax signal occurs may still be lost. Also, to carry out the method, an interleaver and a deinterleaver are required to be redesigned in a UWB terminal and thus, the method is not effective. As described above, a specification of the interleaver is also required to be changed and thus, the interleave may not be compatible with a previous version.

Also, when a basic interleaver is maintained as is, tone mapping must be completely changed. Thus, a storage space capable of storing single symbol data is required. In the case of a processing time, a delay may incur by a single symbol. Also, when a DAA mode and a general mode are installed in parallel, loads may be significantly increased.

FIG. 10 illustrates results of DAA which is carried out by applying the notch filter as described above. In FIG. 10, as illustrated in the left-hand graph, when the notch filter is applied according to the conventional art, the power level is not sufficiently decreased in all bands of about 20 MHz width, i.e. 3.26 GHz to 3.28 GHz corresponding to an interference section. Specifically, a power level in a band of 3.26 GHz was increased about 0.7457 dBm and a power level in a band of 3.28 GHz was decreased about 11.58 dBm.

Conversely, as illustrated in FIG. 11, when DAA is carried out by shifting five null tones of the UWB signal to a band where an interference with the WiMax signal occurs according to an exemplary embodiment of the present invention, about 23 dBm/MHz of power level was decreased in all bands of about 20 MHz width, 3.26 GHz to 3.28 GHz corresponding to the interference section. Thus, according to the present invention, a power level reduction, which is required to carry out the DAA, may be acquired by simply shifting the null tone band to the band where the interference occurs.

Also, as illustrated in FIG. 12, when DAA is carried out by shifting five null tones of the UWB signal to the band where the interference with the WiMax signal occurs, and simultaneously changing all tones, which are included in a guard band of the UWB signal, into null tones, power levels greater than 23 dBm/MHz were sufficiently decreased in all bands of about 20 MHz width, 3.26 GHz to 3.28 GHz, corresponding to the interference section. Thus, when shifting a null tone band to a band where an interference occurs and changing a guard band into a null tone according to the present invention, the power level of the band where the interference occurs may be decreased to be significantly less than a maximum allowable power level and thus, the DAA may be more securely carried out.

As described above, according to a UWB DAA operation of the present invention, the DAA may be more effectively carried out by simply shifting mapped tones, without re-constructing a terminal, such as redesign of an interleaver and a deinterleaver, and the like, which is required in the conventional art.

Also, unlike the conventional art, without a loss of data of five tones, only with a loss of data of just a single tone, DAA may be carried out by changing only a tone, which becomes a new DC term, into a null tone. Also, when data of the single tone, which is lost according to the shift of the DC term, is duplicated in any one tone of the guard band, the DAA may be carried out without data loss.

Also, since the DAA may be carried out with respect to any type of wireless communication network signal, which has about 20 MHz in a interference section, in addition to the WiMax signal, by varying only an m value of the index function signal, an adaptive DAA technology may be expected. Also, a UWB bandwidth, which is required by WiMedia, may be maintained by constructing the guard band for interference cancellation, to reduce a power level of the interference section to be less than a reference level, and a UWB specification may be simply set. Also, even when the DAA mode and the general mode are installed in parallel, loads may not be significantly increased.

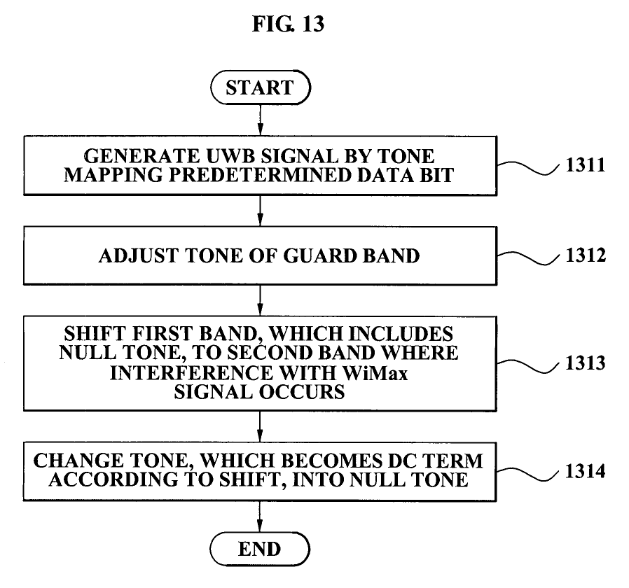

FIG. 13 is a flowchart illustrating a DAA method of a UWB signal with respect to a WiMax signal according to an exemplary embodiment of the present invention.

In operation 1311, a UWB terminal according to the present embodiment generates the UWB signal by tone mapping a predetermined data bit.

In operation 1312, the UWB terminal adjusts at least one tone, which is included in a guard band, among mapped tones of the UWB signal.

Also, in operation 1312, the UWB terminal may invert a sign of the at least one tone, which is included in the guard band. For example, the UWB terminal may invert a sign of a 57^{th} tone, a 59^{th} tone, a sign of a 61^{st} tone, a sign of a 67^{th} tone, a sign of a 69^{th} tone, and a sign of a 71^{st} tone among guard band tones of the UWB signal. Also, in operation 1312, the UWB terminal may adjust a tone of the guard band by changing the at least one tone, which is included in the guard band, into a null tone.

In operation 1313, the UWB terminal controls a first band to shift the first band to a second band where an interference with the WiMax signal occurs. Here, the first band includes a null tone among the mapped tones of the UWB signal. The UWB terminal may shift the first band to the second band by multiplying the UWB signal by an index function signal

$${e}^{j \frac{2 π}{N} nm} .$$

### When DAA with respect to the WiMax signal is carried out, m may be set to 25 in the index function signal.

In operation 1314, the UWB terminal changes a tone, which becomes a DC term according to the shift, into the null tone among the mapped tones of the UWB signal. For example, when the DAA with respect to the WiMax signal is carried out, the tone that becomes the DC term according to the shift may be a 25^{th} tone. Thus, the UWB terminal may change the 25^{th} tone into the null tone according to the shift.

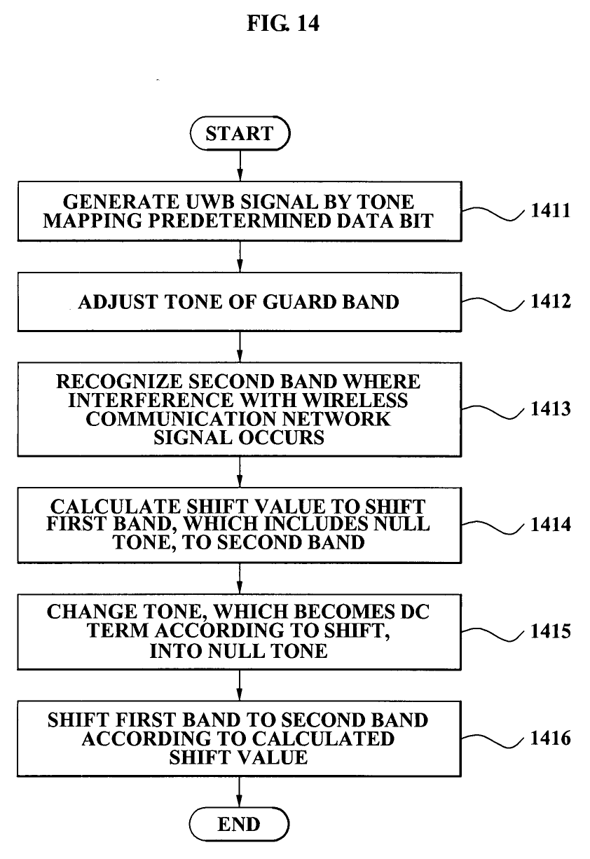

FIG. 14 is a flowchart illustrating a DAA method of a UWB signal with respect to a predetermined wireless communication network signal according to an exemplary embodiment of the present invention.

In operation 1411, a UWB terminal according to the present embodiment generates the UWB signal by tone mapping a predetermined data bit. In operation 1412, the UWB terminal adjust a tone of a guard band by inverting a sign of at least one tone, which is included in the guard band, or changing the at least one tone into a null tone among mapped tones of the UWB signal.

In operation 1413, the UWB terminal recognizes a second band, which includes at least one tone interfering with the wireless communication network signal, among the mapped tones of the UWB signal.

In operation 1414, the UWB terminal calculates a shift value to shift a tone of a first band, which includes the null tone among the mapped tones of the UWB signal, to the second band to thereby include a tone of the second band.

In operation 1415, the UWB terminal changes a tone, which becomes a DC term according to the shift, into the null channel among the mapped tones of the UWB signal.

In operation 1416, the UWB terminal controls the first band to shift the first band to the second band according to the calculated shift value. Also, in operation 1416, the UWB terminal may shift the first band to the second band by multiplying the UWB signal by an index function signal

$${e}^{j \frac{2 π}{N} nm} .$$

### Here, m may be set to the calculated shift value.

Although a DAA method of a UWB signal according to the present invention has been briefly described with reference to FIGS. 13 and 14, the DAA method of the UWB signal described above may include all DAA operations of a UWB signal of a UWB terminal according to the present invention, which has been described with FIGS. 1 through 12.

The DAA method of the UWB according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, there is provided a DAA method of a UWB which can shift a null tone band of a UWB signal to a band where an interference with a predetermined wireless communication network signal occurs, and thereby effectively solve an interference between the UWB signal and other wireless communication network signals with a simple scheme, and a UWB terminal performing the method.

Also, according to the present invention, there is provided a DAA method of a UWB signal which can reduce a data loss when DAA of a UWB signal is performed, since only a single tone is changed into a null tone, and a UWB terminal of performing the method. Here, the single tone becomes a DC term according to a shift, when a null tone band of the UWB signal is shifted.

Also, according to the present invention, there is provided an economical and effective DAA method of a UWB signal which can carry out a DAA operation by simply shifting a tone mapping of a UWB signal and thus does not require a redesign with respect to each module of a UWB terminal, and the UWB terminal of performing the method.

Also, according to the present invention, there is provided a DAA method of a UWB signal which can significantly decrease a power of a corresponding band of a UWB signal where an interference with a predetermined wireless communication network signal occurs by inverting a sign of at least one tone, which is included in a guard band, or changing the at least one tone into a null tone, and a UWB terminal of performing the method. Here, the guard band is provided around the null tone of the shifted UWB signal.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A Detection And Avoidance (DAA) method of a Ultra-Wideband (UWB) signal with respect to a World Interoperability for Microwave Access (WiMax) signal, the method comprising:
generating the UWB signal by tone mapping a predetermined data bit; and
controlling a first band to shift the first band to a second band where an interference with the WiMax signal occurs, the first band comprising a null tone among mapped tones of the UWB signal.

2. The method of claim 1, wherein the predetermined data bit is tone mapped according to a WiMedia UWB specification, and the first band comprises 62^{nd} to 66^{th} tones among 128 tones which are tone mapped according to the WiMedia UWB specification, and the 62^{nd} to 66^{th} tones are null tones.

3. The method of claim 2, wherein the second band comprises 87^{th} to 91^{st} tones among the 128 tones which are tone mapped according to the WiMedia UWB specification.

4. The method of claim 1, wherein the controlling comprises:
multiplying the UWB signal by a predetermined index function signal.

5. The method of claim 4, wherein the predetermined index function signal corresponds to
$${e}^{j \frac{2 π}{N} nm} ,$$
wherein m is 25.

6. The method of claim 1, further comprising:
adjusting at least one tone included in a guard band, among the mapped tones of the UWB signal.

7. The method of claim 6, wherein the guard band comprises a first guard band which comprises 57^{th} to 61^{st} tones and a second guard band which comprises 67^{th} to 71^{st} tones, among the 128 tones which are the mapped tones of the UWB signal, and
the adjusting comprises:
inverting a sign of the 57^{th} tone, a sign of the 59^{th} tone, and a sign of the 61^{st} tone, among tones of the first guard band; and
inverting a sign a sign of the 67^{th} tone, a sign of the 69^{th} tone, and a sign of the 71^{st} tone, among tones of the second guard band.

8. The method of claim 6, wherein the guard band comprises a first guard band which comprises 57^{th} to 61^{st} tones and a second guard band which comprises 67^{th} to 71^{st} tones, among the 128 tones which are the mapped tones of the UWB signal, and
the adjusting comprises:
changing the at least one tone included in the first guard band and the second guard band, into the null tone.

9. The method of claim 1, further comprising:
changing a tone which becomes a direct current (DC) term according to the shift, into the null tone among the mapped tones of the UWB signal.

10. The method of claim 9, wherein the DC term is a 0^{th} tone, and the tone which becomes the DC term according to the shift, is a 25^{th} tone among the mapped tones of the UWB signal.

11. A Detection And Avoidance (DAA) method of an Ultra-Wideband (UWB) signal with respect to a World Interoperability for Microwave Access (WiMax) signal, the method comprising:
generating the UWB signal by tone mapping a predetermined data bit;
inverting a sign of at least one tone included in a guard band, or changing the at least one tone into a null tone among mapped tones of the UWB signal; and
controlling a first band to shift the first band to a second band where an interference with the WiMax signal occurs, the first band comprising the null tone among the mapped tones of the UWB signal.

12. The method of claim 11, wherein the controlling comprises:
multiplying the UWB signal by a predetermined index function signal, and
the predetermined index function signal corresponds to
$${e}^{j \frac{2 π}{N} nm} ,$$
wherein m is 25.

13. The method of claim 11, further comprising:
changing a tone which becomes a direct current (DC) term according to the shift, into the null tone among the mapped tones of the UWB signal.

14. A Detection And Avoidance (DAA) method of an Ultra-Wideband (UWB) signal with respect to a World Interoperability for Microwave Access (WiMax) signal, the method comprising:
generating the UWB signal by tone mapping a predetermined data bit;
controlling a first band to shift the first band to a second band where an interference with the WiMax signal occurs, the first band comprising a null tone among the mapped tones of the UWB signal; and
changing a tone which becomes a direct current (DC) term according to the shift, into the null tone among the mapped tones of the UWB signal.

15. The method of claim 14, wherein the controlling comprises:
multiplying the UWB signal by a predetermined index function signal, and
the predetermined index function signal corresponds to
$${e}^{j \frac{2 π}{N} nm} ,$$
wherein m is 25.

16. The method of claim 14, further comprising:
inverting a sign of at least one tone included in a guard band, or changing the at least one tone to the null tone among the mapped tones of the UWB signal.

17. A Detection And Avoidance (DAA) method of an Ultra-Wideband (UWB) signal with respect to an World Interoperability for Microwave Access (WiMax) signal, the method comprising:
generating the UWB signal by tone mapping a predetermined data bit;
inverting a sign of at least one tone included in a guard band, or changing the at least one tone into a null tone among the mapped tones of the UWB signal;
controlling a first band to shift the first band to a second band where an interference with the WiMax signal occurs, the first band comprising the null tone among the mapped tones of the UWB signal; and
changing a tone which becomes a direct current (DC) term according to the shift, into the null tone among the mapped tones of the UWB signal.

18. The method of claim 17, wherein the controlling comprises:
multiplying the UWB signal by a predetermined index function signal, and
the predetermined index function signal corresponds to
$${e}^{j \frac{2 π}{N} nm} ,$$
wherein m is 25.

19. A Detection And Avoidance (DAA) method of an Ultra-Wideband (UWB) signal with respect to a predetermined wireless communication network signal, the method comprising:
generating the UWB signal by tone mapping a predetermined data bit;
controlling information about a second band comprising at least one tone interfering with the wireless communication network signal, among mapped tones of the UWB signal; and
controlling a first band to shift the first band to the second band, the first band comprising a null tone among the mapped tones of the UWB signal.

20. The method of claim 19, wherein the second band includes up to five tones.

21. The method of claim 19, wherein the predetermined data bit is tone mapped according to a WiMedia UWB specification, and the first band comprises 62^{nd} to 66^{th} tones among 128 tones which are tone mapped according to the WiMedia UWB specification, and the 62^{nd} to 66^{th} tones are null tones, and
the controlling of the information comprises:
recognizing a tone included in the second band, among the mapped tones of the UWB signal; and
calculating a shift value to shift the 62^{nd} to 66^{th} tones of the first band to the second band to thereby include all tones of the second band.

22. The method of claim 21, wherein the controlling of the first band comprises:
multiplying the UWB signal by a predetermined index function signal, and
the predetermined index function signal corresponds to
$${e}^{j \frac{2 π}{N} nm} ,$$
wherein m is the calculated shift value.

23. The method of claim 19, further comprising:
inverting a sign of at least one tone included in a guard band, among the mapped tones of the UWB signal.

24. The method of claim 19, further comprising:
changing at least one tone included in a guard band, into the null tone among the mapped tones of the UWB signal.

25. The method of claim 19, further comprising:
changing a tone which becomes a direct current (DC) term according to the shift, into the null tone among the mapped tones of the UWB signal.

26. A Detection And Avoidance (DAA) method of an Ultra-Wideband (UWB) signal with respect to a predetermined wireless communication network signal, the method comprising:
generating the UWB signal by tone mapping a predetermined data bit;
inverting a sign of at least one tone included in a guard band, or changing the at least one tone into a null tone among the mapped tones of the UWB signal;
recognizing a second band which at least one tone interfering with the wireless communication network signal, among the mapped tones of the UWB signal;
calculating a shift value to shift a tone of a first band which includes the null tone among the mapped tones of the UWB signal, to the second band to thereby include a tone of the second band;
changing a tone which becomes a direct current (DC) term according to the shift, into the null tone among the mapped tones of the UWB signal; and
controlling the first band to shift the first band to the second band according to the calculated shift value.

27. The method of claim 26, wherein the predetermined data bit is tone mapped according to a WiMedia UWB specification, and the first band includes 62^{nd} to 66^{th} tones among 128 tones which are tone mapped according to the WiMedia UWB specification, and the 62^{nd} to 66^{th} tones are null tones.

28. The method of claim 26, wherein the controlling comprises:
multiplying the UWB signal by a predetermined index function signal, and
the predetermined index function signal corresponds to
$${e}^{j \frac{2 π}{N} nm} ,$$
wherein m is the calculated shift value.

29. A computer-readable recording medium storing a program for implementing the method according to claim 1.

30. An Ultra-Wideband (UWB) terminal comprising:
a tone mapping module which generates a UWB signal by tone
a tone mapping module which generates a UWB signal by tone mapping a predetermined data bit;
a Detection And Avoidance (DAA) control module which controls information about a second band that includes at least one tone interfering with a wireless communication network signal among mapped tones of the UWB signal; and
a shift control module which controls a first band to shift the first band to the second band, the first band comprising a null tone among the mapped tones of the UWB signal.

31. The UWB terminal of claim 30, wherein the second band includes up to five tones.

32. The UWB terminal of claim 30, wherein the predetermined data bit is tone mapped according to a WiMedia UWB specification, and the first band includes 62^{nd} to 66^{th} tones among 128 tones which are tone mapped according to the WiMedia UWB specification, and the 62^{nd} to 66^{th} tones are null tones, and
the DAA control module recognizes a tone included in the second band, among the mapped tones of the UWB signal, and calculates a shift value to shift the 62^{nd} to 66^{th} tones of the first band to thereby include all tones of the second band.

33. The UWB terminal of claim 32, wherein the shift control module multiplies the UWB signal by a predetermined index function signal via a predetermined multiplier and thereby controls the first band to shift the first band to the second band, and the predetermined index function signal corresponds to
$${e}^{j \frac{2 π}{N} nm} ,$$
wherein m is the calculated shift value.

34. The UWB terminal of claim 30, wherein the DAA control module inverts a sign of at least one tone included in a guard band, among the mapped tones of the UWB.

35. The UWB terminal of claim 30, wherein the DAA control module changes at least one tone included in a guard band, into the null tone among the mapped tones of the UWB signal.

36. The UWB terminal of claim 30, wherein the DAA control module changes a tone which becomes a direct current (DC) term according to the shift, into the null tone among the mapped tones of the UWB signal.

37. A Detection And Avoidance (DAA) method for a Ultra-Wideband (UWB) signal for reducing interference with a wireless communication signal, the method comprising:
generating the UWB signal; and
cyclic-shifting the UWB signal so that a null tone of the UWB signal is shifted to a location where there is an overlap of the wireless communication signal and the UWB signal.
